(19) United States
(12) Patent Application Publication
(10) Pub. No.: US 2026/0341585 A1
(43) Pub. Date: Oct. 29, 2026

(54) TRANSFORMER AND METHOD OF MANUFACTURING THE SAME

(71) Applicant: LG INNOTEK CO., LTD., Seoul (KR)

(72) Inventors: Yong Hwan KIM, Seoul (KR); Bi Yi KIM, Seoul (KR); Seung Eun LEE, Seoul (KR)

(21) Appl. No.: 19/119,015

(22) PCT Filed: Oct. 6, 2023
(86) PCT No.: PCT/KR2023/015406

§ 371 Date: Apr. 7, 2025

(30) Foreign Application Priority Data
Oct. 6, 2022 (KR) 10-2022-0127808

(51) Int. Cl. H01F 27/32; H01F 27/24; H01F 41/02; H01F 41/06; H01F 41/12

(52) U.S. Cl. CPC H01F 27/325; H01F 27/24; H01F 41/0206; H01F 41/06; H01F 41/12

(57) ABSTRACT

The present invention relates to a transformer having a first insulating layer inserted between multiple coils on the secondary side. The transformer according to the present invention comprises: a core portion having an upper core and a lower core; a primary coil wound around a first bobbin and contained in the core portion; and a secondary coil inserted into a second bobbin and disposed on a side portion of the primary coil. The secondary coil comprises: a first insulating layer; a (2-1)th coil disposed on the upper portion of the first insulating layer; and a (2-2)th coil disposed on the lower portion of the first insulating layer. A first insulating portion and a second insulating portion are disposed between the (2-1)th coil and the (2-2)th coil, and have different lamination numbers.

### CROSS-REFERENCE TO RELATED APPLICATIONS

This application is the U.S. national stage application of International Patent Application No. PCT/KR2023/015406, filed Oct. 6, 2023, which claims the benefit under 35 U.S.C. § 119 of Korean Application No. 10-2022-0127808, filed Oct. 6, 2022, the disclosures of each of which are incorporated herein by reference in their entirety.

### TECHNICAL FIELD

The present disclosure relates to a transformer, and more particularly, to a transformer having a structure in which a first insulating layer is inserted between a plurality of secondary-side conductive plates and a method of manufacturing the same.

### BACKGROUND ART

In general, driving power is required in order to drive an electronic device, and a power supply device, such as a power supply unit (PSU), is essentially employed in order to supply driving power to the electronic device.

In particular, a display device, such as a flat panel TV, is required to be slim, and is continually being embodied in increasingly larger sizes. Accordingly, it is necessary to reduce the thickness of such a large-scale display while meeting the increased power requirements thereof.

In the power supply unit (PSU), a transformer occupies a relatively large volume compared to other elements. In order to realize a slim transformer, a method of omitting thick elements from the transformer or adjusting the number thereof is generally considered. For example, in recent years, a bobbin, around which a primary coil and a secondary coil are wound so as to be secured thereto, has been omitted from a transformer constituting a power supply unit of a flat panel display device, or a plurality of low-capacity slim transformers has been adopted.

In such a PSU, increase in secondary-side parasitic capacitance may cause variation in output voltage under no-load conditions.

### DISCLOSURE

### Technical Problem

The present disclosure has been made to solve the above problems with the related art, and an object of the present disclosure is to provide a transformer capable of maintaining a secondary-side parasitic capacitance.

Another object of the present disclosure is to provide a transformer capable of inhibiting increase in secondary-side parasitic capacitance in the transformer after molding.

### Technical Solution

A transformer according to an embodiment of the present disclosure for accomplishing the above objects may include a core unit including an upper core and a lower core, a primary coil wound on a first bobbin to be accommodated in the core unit, a secondary coil inserted into a second bobbin to be disposed beside the primary coil, and a secondary coil inserted into a second bobbin to be disposed beside the primary coil, wherein the secondary coil may include a first insulating layer, a 2-1^{st} coil disposed on the first insulating layer, and a 2-2^{nd} coil disposed under the first insulating layer,
the secondary coil may include a first insulating layer disposed between a plurality of coils in which a first insulating portion and a second insulating portion formed in different numbers of layers are disposed between the 2-1^{st} coil and the 2-2^{nd} coil, a 2-1^{st} coil disposed on the first insulating layer, and a 2-2^{nd} coil disposed under the first insulating layer, and a first insulating portion and a second insulating portion formed in different numbers of layers may be disposed between the 2-1^{st} coil and the 2-2^{nd} coil.

In the transformer according to the present disclosure, the first insulating portion may include the first insulating layer, a 2-1^{st} insulating layer between a lower portion of the 2-1^{st} coil and an upper portion of the first insulating layer, and a 2-2^{nd} insulating layer between an upper portion of the 2-2^{nd} coil and a lower portion of the first insulating layer.

In the transformer according to the present disclosure, the first insulating layer may have a width less than the widths of the 2-1^{st} coil and the 2-2^{nd} coil.

In the transformer according to the present disclosure, the second insulating portion may be formed by the 2-1^{st} insulating layer and the 2-2^{nd} insulating layer extending to opposite sides of the first insulating layer.

The transformer according to the present disclosure may include a third insulating portion formed by the second insulating portion extending between a middle portion of the second bobbin and the secondary coil.

The transformer according to the present disclosure may include a fourth insulating portion formed by the third insulating portion extending between a top portion of the second bobbin and the 2-2^{nd} coil and between a bottom portion of the second bobbin and the 2-1^{st} coil.

In the transformer according to the present disclosure, the second insulating portion may have a thickness greater than the overall thickness of the fourth insulating portion.

In the first insulating portion of the transformer according to the present disclosure, the first insulating layer may have a thickness greater than the thicknesses of the 2-1^{st} insulating layer and the 2-2^{nd} insulating layer.

In the transformer according to the present disclosure, the first insulating portion may have a width greater than the width of the second insulating portion.

In the first insulating portion of the transformer according to the present disclosure, the first insulating layer may have a thickness greater than the thicknesses of the 2-1^{st} insulating layer and the 2-2^{nd} insulating layer.

### Advantageous Effects

The transformer and the method of manufacturing the same according to the present disclosure may maintain a constant distance between a plurality of coils constituting a secondary coil, thereby inhibiting increase in parasitic capacitance.

In addition, it may be possible to inhibit the output voltage of the transformer from varying due to increase in secondary-side parasitic capacitance.

### DESCRIPTION OF DRAWINGS

FIG. 1 is an exploded perspective view showing an example of the configuration of a transformer according to an embodiment of the present disclosure.

FIG. 2 is a plan view showing the shape of a secondary coil in which a first insulating layer is disposed between two coils.

FIG. 3 is a flowchart showing a progressing process of a method of manufacturing a transformer according to an embodiment of the present disclosure.

FIG. 4 is a view illustrating the shape of a first bobbin included in the transformer according to the present disclosure.

FIGS. 5A to 5D are views illustrating a secondary coil assembly process.

FIG. 6 is a view illustrating a process of combining an upper core and a lower core in a molded state.

FIG. 7A is a cross-sectional view showing an example of the completely assembled transformer cut in a y direction.

FIG. 7B is a cross-sectional view showing the configuration of the secondary coil in FIG. 7A in detail.

### BEST MODE

Various exemplary embodiments will now be described more fully with reference to the accompanying drawings, in which only some exemplary embodiments are shown. Specific structural and functional details disclosed herein are merely representative for the purpose of describing exemplary embodiments. The present disclosure, however, may be embodied in many alternative forms, and should not be construed as being limited to the exemplary embodiments set forth herein.

Accordingly, while exemplary embodiments of the disclosure are capable of being variously modified and taking alternative forms, embodiments thereof are shown by way of example in the drawings and will herein be described in detail. It should be understood, however, that there is no intent to limit the present disclosure to the particular exemplary embodiments disclosed. On the contrary, exemplary embodiments are to cover all modifications, equivalents, and alternatives falling within the scope of the disclosure.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between”, “adjacent” versus “directly adjacent”, etc.).

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Meanwhile, when a certain embodiment is capable of being realized in a different manner, functions or operations specified in a specific block may be executed in an order different from that shown in a flowchart. For example, two consecutive blocks may be executed simultaneously, or may be executed in the reverse order, depending on the related function or operation.

Hereinafter, a transformer and a method of manufacturing the same according to the present disclosure will be described with reference to the accompanying drawings.

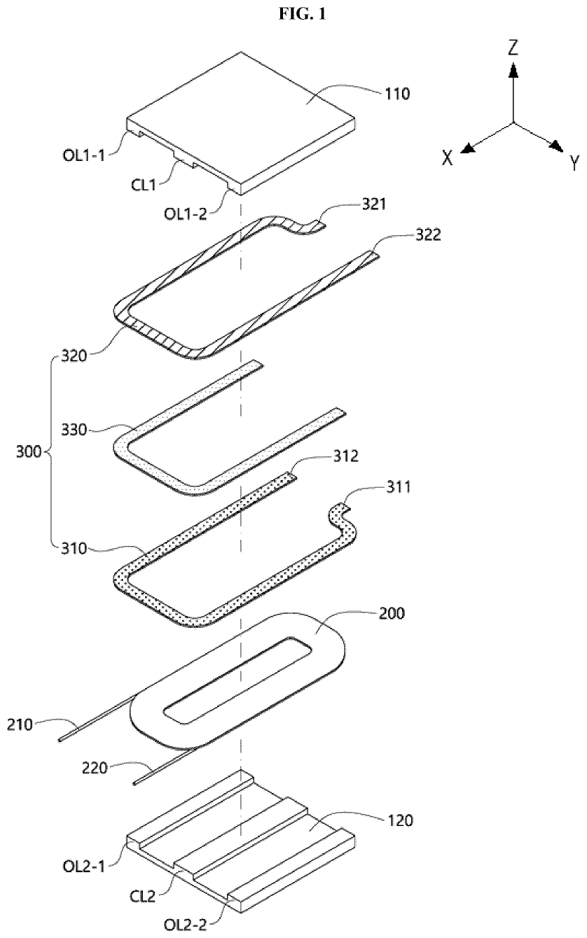

FIG. 1 is an exploded perspective view showing an example of the configuration of a transformer according to an embodiment of the present disclosure. Referring to FIG. 1, a transformer according to an embodiment includes a core unit 110 and 120 and a coil unit 200 and 300.

The core unit 110 and 120 may have the characteristics of a magnetic circuit and thus may act as a path for magnetic flux. The core unit 110 and 120 may include an upper core 110, which is disposed at an upper position, and a lower core 120, which is disposed at a lower position. The two cores 110 and 120 may be formed to be symmetrical or asymmetrical with each other in the vertical direction. However, for convenience of explanation, the following description will be given on the assumption that the two cores are formed to be vertically symmetrical with each other.

Each of the upper core 110 and the lower core 120 may include a body portion, which has a flat plate shape, and a plurality of leg portions OL1-1, OL1-2, OL2-1, OL2-2, CL1, and CL2, which protrude from the body portion in a thickness direction (i.e., a Z-axis direction) and extend in a predetermined direction. For example, the plurality of leg portions OL1-1, OL1-2, and CL1 of the upper core 110 may include two outer legs OL1-1 and OL1-2, which extend in one axis (e.g., an X-axis) direction and are spaced apart from each other in another axis (e.g., a Y-axis) direction when viewed in a plan view, and one center leg CL1, which is disposed between the two outer legs OL1-1 and OL1-2.

When the upper core 110 and the lower core 120 are coupled to each other in the vertical direction, each of the outer legs OL1-1 and OL1-2 and the center leg CL1 of the upper core 110 faces a corresponding one of the outer legs OL2-1 and OL2-2 and the center leg CL2 of the lower core 120. In this case, a gap having a predetermined distance (e.g., 10 to 100 μm, without being necessarily limited thereto) may be formed between at least one pair among the pairs of outer legs OL1-1, OL1-2, OL2-1, and OL2-2 and the pair of center legs CL1 and CL2, which face each other. In addition, the core unit 110 and 120 may include a magnetic material, for example, iron or ferrite, but the disclosure is not necessarily limited thereto.

The coil unit 200 and 300 may include a primary coil 200 and a secondary coil 300.

The primary coil 200 may be wound around the center legs CL1 and CL2, and may be a multiple winding coil in which a rigid metallic conductor, for example, a copper conductive wire, is wound multiple times in a spiral or planar spiral shape, but the disclosure is not necessarily limited thereto. For example, an enamel wire (USTC wire) wrapped by a fiber yarn, a Litz wire, a triple insulated wire (TIW), or the like may be used for the primary coil 200.

The secondary coil 300 may include a 2-1^{st} coil 310, a 2-2^{nd} coil 320, and a first insulating layer 330 disposed between the two coils 310 and 320, which have a planar shape.

The 2-1^{st} coil 310 and the 2-2^{nd} coil 320 may include conductive metal, e.g., copper or aluminum, and may have planar shapes that are bilaterally symmetrical to each other, but the disclosure is not necessarily limited thereto.

The 2-1^{st} coil 310 and the 2-2^{nd} coil 320 may be aligned and stacked around the center legs CL1 and CL2 of the core unit 110 and 120, and each thereof may form one turn.

End portions 311, 312, 321, and 322 of the coils 310 and 320 may be led out in the same direction, and this lead-out direction may be opposite the direction in which two end portions 210 and 220 of the conductive wire constituting the primary coil 200 are led out, but the disclosure is not necessarily limited thereto.

Central end portions of the 2-1^{st} coil 310 and the 2-2^{nd} coil 320 have a short-circuit pattern in a center tap structure.

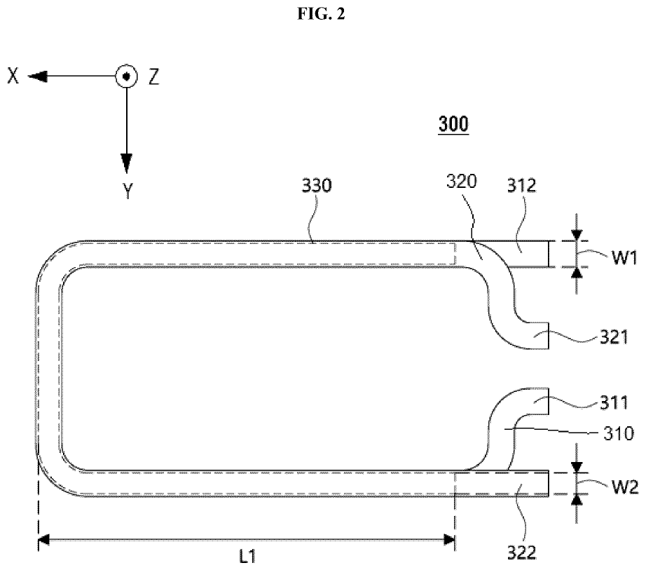

As shown in FIG. 2, the first insulating layer 330 may have a “U” shape according to the shapes of the two coils 310 and 320, and the width W2 of the first insulating layer 330 may be equal to or less than the widths W1 of the two coils 310 and 320. The length L1 of one side of the first insulating layer 330 is formed to be less than the length of the straight portion of each of the two coils 310 and 320. The first insulating layer 330 may include one of a ketone, a polyimide-based material, polyethylene terephthalate (PET), silicone, and an epoxy-based material.

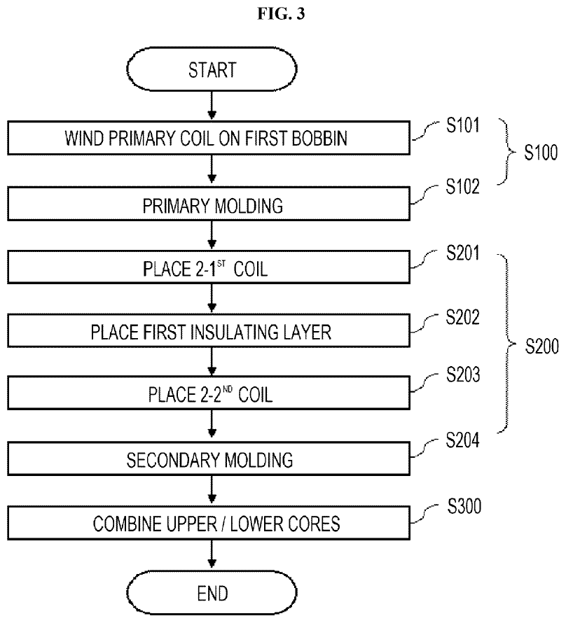

FIG. 3 is a flowchart showing a process of manufacturing a transformer according to an embodiment of the present disclosure. The process of manufacturing a transformer according to the present disclosure broadly includes a primary coil unit forming process S100, a secondary coil unit forming process S200, and an upper/lower core combining process S300.

The primary coil unit forming process S100 includes a step of winding a primary coil 200 on a first bobbin 510 (S101) and a step of performing primary molding after completion of the winding (S102).

The secondary coil unit forming process S200 includes a step of placing a 2-1^{st} coil 310 in a second bobbin 520 (S201), a step of placing a first insulating layer 330 on the 2-1^{st} coil 310 (S202), a step of placing a 2-2^{nd} coil 320 on the first insulating layer 330 (S203), and a step of performing secondary molding after completion of the placement of the secondary coil 300 (310, 320, and 330) (S204).

Hereinafter, the transformer assembly process according to the present disclosure will be described in more detail.

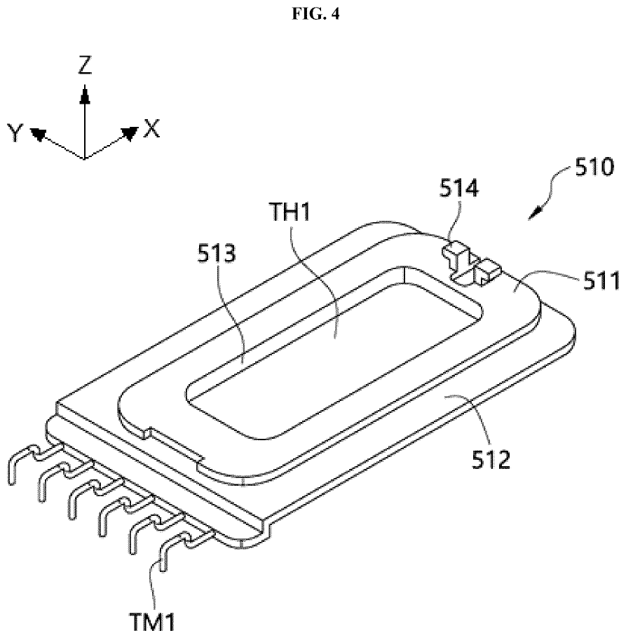

First, as shown in FIG. 4, the first bobbin 510 is prepared. The first bobbin 510 may include a first top portion 511, a first middle portion 513, and a first bottom portion 512. Each of the first top portion 511 and the first bottom portion 512 may have a rectangular planar shape with rounded corners, but the disclosure is not necessarily limited thereto. In addition, the first bottom portion 512 may have a planar shape extending farther outward than the first top portion 511 in the spacing direction of the leg portions (i.e., the Y-axis direction).

The first middle portion 513 may be disposed between the first top portion 511 and the first bottom portion 512 in the vertical direction (i.e., the Z-axis direction) , and may insulate the conductive wire (not shown) constituting the primary coil 200 and the center legs CL1 and CL2 from each other. The space defined by the lower surface of the first top portion 511, the outer side surface of the first middle portion 513, and a portion of the upper surface of the first bottom portion 512 may function as an accommodation space accommodating the conductive wire constituting the primary coil 200.

After the primary coil 200 is wound on the first bobbin 510, primary injection molding is performed in order to firmly fix the primary coil 200. Although the first bobbin 510 is filled with an injection-molding liquid, a distance from the secondary coil 300 is maintained, so that a parasitic capacitance value may be maintained.

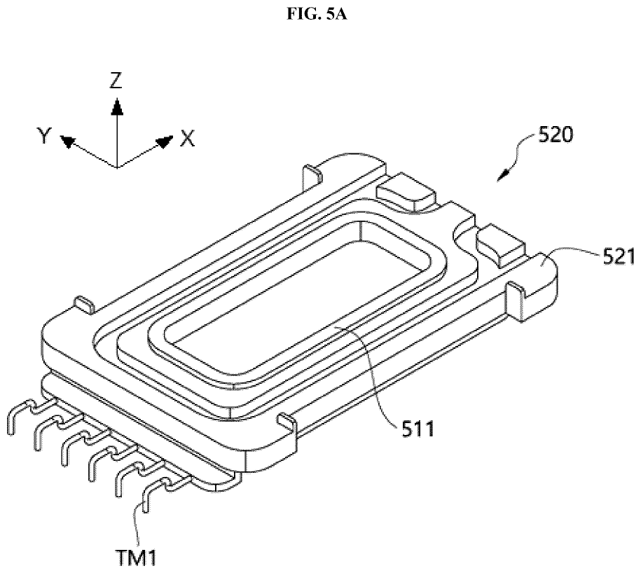

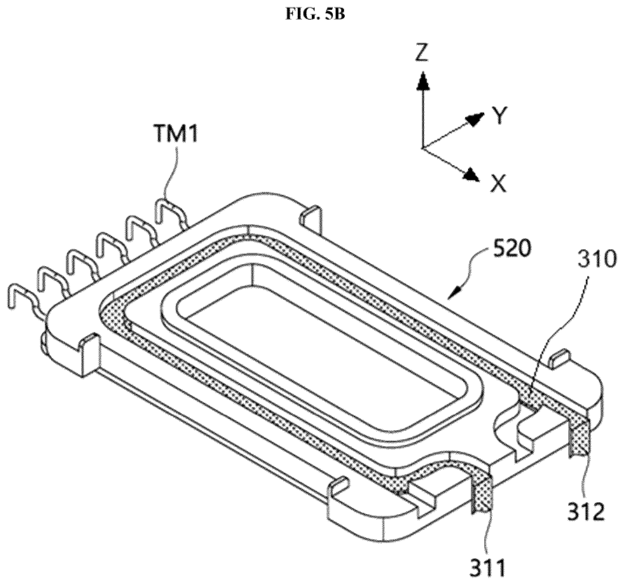

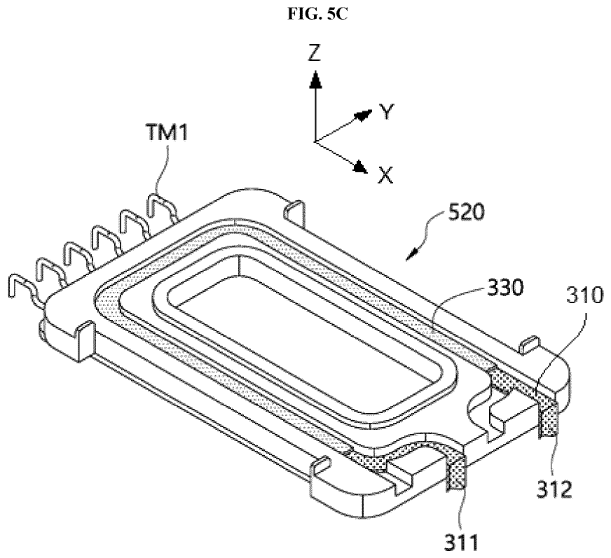

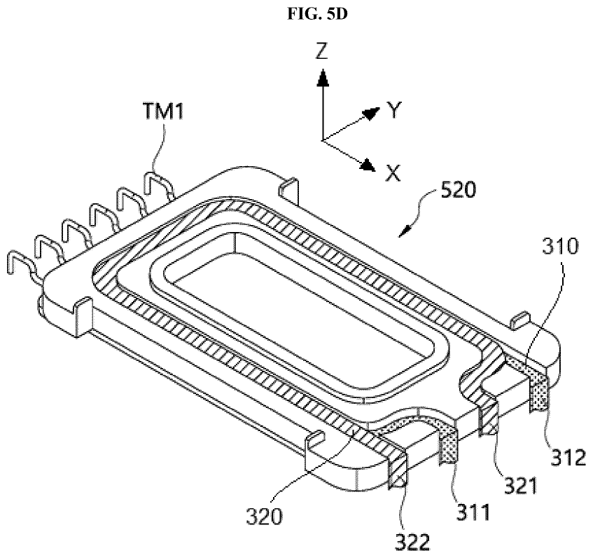

After the primary coil unit is formed, the second bobbin 520 to be placed outside the primary coil 200 is prepared, as shown in FIGS. 5A-5D. The second bobbin 520 may include a second top portion 521 and a second bottom portion 522. Although not shown, a second middle portion may be disposed between the second top portion 521 and the second bottom portion 522 in the vertical direction to insulate the primary coil 200 and the secondary coil 300 from each other.

As shown in FIG. 5B, a 2-1^{st} coil 310 is inserted and placed between the second bottom portion 522 and the second top portion 521 of the second bobbin 520. In this case, termination end portions 311 and 312 of the 2-1^{st} coil 310 are disposed in a direction opposite a terminal portion TM1 of the first bobbin 510.

Subsequently, as shown in FIG. 5C, a first insulating layer 330 is placed on the 2-1^{st} coil 310. Subsequently, as shown in FIG. 5D, a 2-2^{nd} coil 320 is placed on the first insulating layer 330 such that termination end portions 321 and 322 thereof are disposed in a direction opposite the terminal portion TM1 of the first bobbin 510, and then secondary molding is performed.

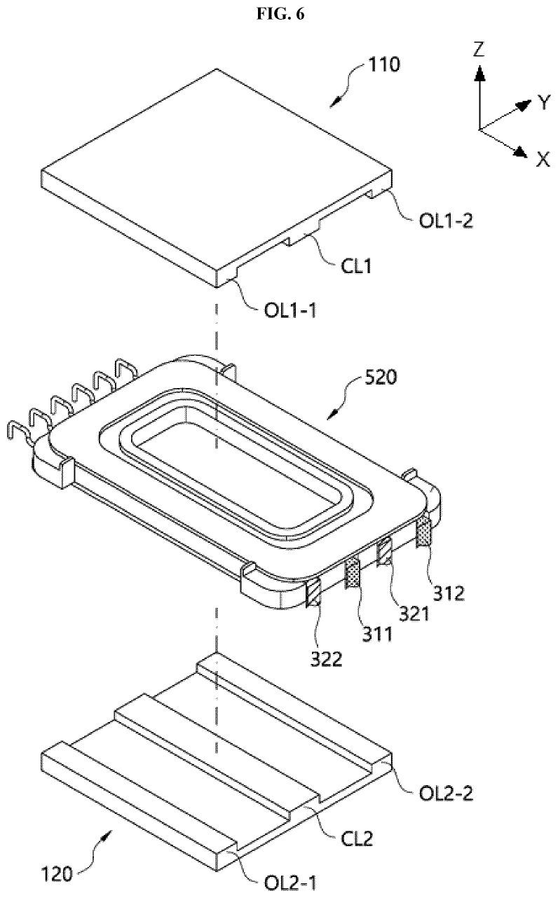

After the secondary injection molding is performed, as shown in FIG. 6, the upper core 110 and the lower core 120 are placed above and below the bobbin and are combined therewith.

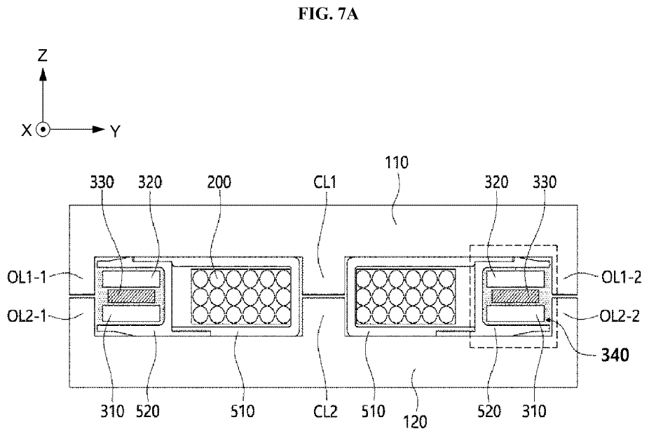

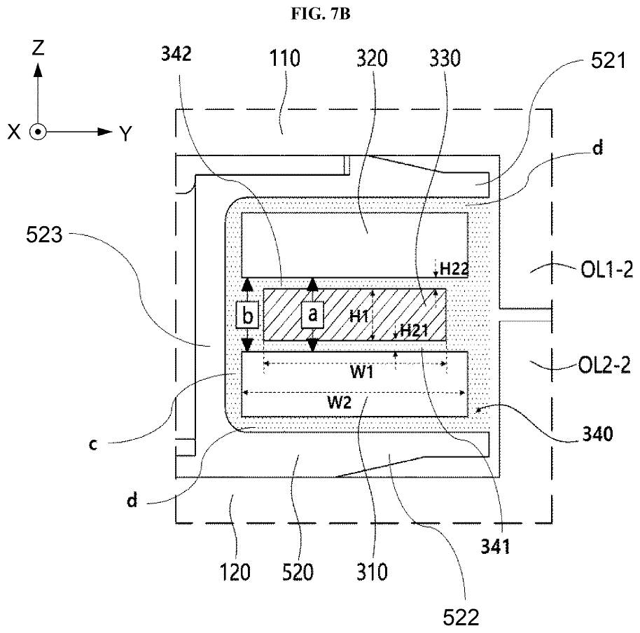

FIG. 7A is a cross-sectional view showing an example of the completely assembled transformer cut in a YZ plane defined by the Y-axis direction and the Z-axis direction, and FIG. 7B is a cross-sectional view showing the configuration of the secondary coil in FIG. 7A in detail.

The first and second bobbins 510 and 520 are disposed between the core unit 110 and 120 and the coil unit 200 and 300.

A structure symmetric with respect to the center legs CL1 and CL2 of the upper core 110 and the lower core 120 facing each other is shown. The primary coil 200 and the secondary coil 300 may be located between the center legs CL1 and CL2 and the outer legs OL1-1 and OL2-1 on one side and between the center legs CL1 and CL2 and the outer legs OL1-2 and OL2-2 on the opposite side.

The primary coil 200 is wound on the first bobbin 510, and the first insulating layer 330 is disposed between the 2-1^{st} coil 310 and the 2-2^{nd} coil 320 constituting the secondary coil 300. A molded portion 340 is formed as an insulating filler in a space of the second bobbin 520 that is occupied by the secondary coil 300.

A total of four insulating portions is included between the secondary coil 300 and the second bobbin 520 of the transformer according to the present disclosure. A first insulating portion a is formed in multiple layers, and a second insulating portion b is formed in a single layer. That is, the insulating portions have different numbers of layers. The first insulating portion a includes a first insulating layer 330 disposed between the 2-1^{st} coil 310 and the 2-2^{nd} coil 320, a 2-1^{st} insulating layer 341 between the 2-1^{st} coil 310 and the first insulating layer 330, and a 2-2^{nd} insulating layer 342 between the 2-2^{nd} coil 320 and the first insulating layer 330. The second insulating portion b is formed by the 2-1st insulating layer 341 and the 2-2^{nd} insulating layer 342 extending to opposite sides of the first insulating layer 330 to form a single layer.

Hereinafter, the term “width” refers to a length in the Y-axis direction, and the term “thickness” refers to a length in the Z-axis direction. The width w1 of the first insulating portion a is greater than the width W2-w1 of the second insulating portion b.

A third insulating portion c is formed by the second insulating portion b extending between a middle portion 523 of the second bobbin 520 and the secondary coil 300.

A fourth insulating portion d includes an insulating area formed by the third insulating portion c extending between a top portion 521 of the second bobbin and the 2-2^{nd} coil 320 and an insulating area formed by the third insulating portion c extending between a bottom portion 522 of the second bobbin and the 2-1^{st} coil 310.

The width W1 of the first insulating layer 330 is less than the widths W2 of the 2-1^{st} coil 310 and the 2-2^{nd} coil 320.

In the first insulating portion a, the thickness H1 of the first insulating layer 330 is greater than the sum of the thickness H21 of the 2-1^{st} insulating layer 341 and the thickness H22 of the 2-2^{nd} insulating layer 342.

The thickness of the second insulating portion b is greater than the sum of those of the two insulating areas of the fourth insulating portion d.

In this way, the 2-1^{st} coil 310 and the 2-2^{nd} coil 320 are forcibly separated from each other using the first insulating layer 330, and then injection molding is performed, whereby increase in parasitic capacitance may be minimized, and accordingly, it may be possible to reduce the occurrence of output voltage malfunction under TV power no-load operation conditions.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

### INDUSTRIAL APPLICABILITY

The transformer according to the present disclosure may be used as a unit that supplies power in a flat panel display device.

1. A transformer, comprising:
a core unit including an upper core and a lower core;
a primary coil wound on a first bobbin and accommodated in the core unit; and
a secondary coil inserted into a second bobbin and disposed on an outer side of the primary coil,
wherein the secondary coil includes:
a first insulating layer;
a 2-1^{st} coil disposed on the first insulating layer; and
a 2-2^{nd} coil disposed under the first insulating layer, and
wherein a first insulating portion and a second insulating portion, each formed in different numbers of layers-layers, are disposed between the 2-1^{st} coil and the 2-2^{nd} coil.

2. The transformer according to claim 1, wherein the first insulating portion includes:
the first insulating layer;
a 2-1^{st} insulating layer between a lower portion of the 2-1^{st} coil and an upper portion of the first insulating layer; and
a 2-2^{nd} insulating layer between an upper portion of the 2-2^{nd} coil and a lower portion of the first insulating layer.

3. The transformer according to claim 1, wherein the first insulating layer has a width less than widths of the 2-1^{st} coil and the 2-2^{nd} coil.

4. The transformer according to claim 2, wherein the second insulating portion is formed by the 2-1^{st} insulating layer and the 2-2^{nd} insulating layer extending to both sides of the first insulating layer.

5. The transformer according to claim 4, comprising a third insulating portion formed by the second insulating portion extending between a middle portion of the second bobbin and the secondary coil.

6. The transformer according to claim 5, comprising a fourth insulating portion formed by the third insulating portion extending between a top portion of the second bobbin and the 2-2^{nd} coil, and between a bottom portion of the second bobbin and the 2-1^{st} coil.

7. The transformer according to claim 6, wherein the second insulating portion has a thickness greater than an overall thickness of the fourth insulating portion.

8. The transformer according to claim 2, wherein, in the first insulating portion, the first insulating layer has a thickness greater than thicknesses of the 2-1^{st} insulating layer and the 2-2^{nd} insulating layer.

9. The transformer according to claim 1, wherein the first insulating portion has a width greater than a width of the second insulating portion.

10. The transformer according to claim 2, wherein, in the first insulating portion, the first insulating layer has a thickness greater than a sum of a thickness of the 2-1^{st} insulating layer and a thickness of the 2-2^{nd} insulating layer.

11. A transformer, comprising:
a core unit;
a bobbin at least partially disposed in the core unit; and
a coil unit disposed on the bobbin;
wherein the coil unit comprises:
a primary coil; and
a secondary coil disposed on an outer side of the primary coil,
wherein the secondary coil comprises:
a 2-1^{st} coil and a 2-2^{nd} coil disposed vertically with respect to each other; and
a first insulating layer interposed between the 2-1^{st} coil and the 2-2^{nd} coil to insulate the 2-1^{st} coil from the 2-2^{nd} coil.

12. The transformer according to claim 11, wherein the first insulating layer has a width equal to or less than that of at least one of the 2-1^{st} coil or the 2-2^{nd} coil.

13. The transformer according to claim 11, wherein the bobbin comprises:
a first bobbin on which the primary coil is disposed; and
a second bobbin disposed on an outer side of the primary coil and on which the secondary coil is disposed,
wherein at least a portion of the second bobbin is interposed between the primary coil and the secondary coil to insulate the primary coil from the secondary coil.

14. The transformer according to claim 13, comprising an insulating portion interposed between the secondary coil and the second bobbin,
wherein the insulating portion comprises:
a first insulating portion comprising a 2-1^{st} insulating layer interposed between the 2-1^{st} coil and the first insulating layer, and a 2-2^{nd} insulating layer interposed between the 2-2^{nd} coil and the first insulating layer;
a second insulating portion formed by extension of the first insulating portion and interposed between the 2-1^{st} coil and the 2-2^{nd} coil;
a third insulating portion formed by extension of the second insulating portion and interposed between the second bobbin and both of the 2-1^{st} coil and the 2-2^{nd} coil; and
a fourth insulating portion formed by extension of the third insulating portion and interposed between the second bobbin and the 2-1^{st} coil, and between the second bobbin and the 2-2^{nd} coil.

15. The transformer according to claim 14, wherein each thickness of the first to fourth insulating portions is different from one another.

16. A transformer, comprising:
a core unit;
a coil unit at least partially disposed in the core unit; and
an insulating member configured to surround the coil part;
wherein the coil unit comprises:
a primary coil; and
a secondary coil disposed to be spaced apart from and outward of the primary coil,
wherein the secondary coil comprises a 2-1^{st} coil and a 2-2^{nd} coil disposed vertically with respect to each other, and
wherein the insulating member comprises a first insulating portion and a second insulating portion, which are disposed between the 2-1^{st} coil and the 2-2^{nd} coil and each having different numbers of stacked layers.

17. The transformer according to claim 16, comprising a bobbin on which the coil unit is disposed, and
wherein at least a portion of the bobbin is disposed between the primary coil and the secondary coil to insulate the primary coil form the secondary coil.

18. The transformer according to claim 17, wherein the insulating member is disposed in a space within the bobbin that is not occupied by the coil part, and is configured to insulate and secure the coil unit.

19. A method of manufacturing the transformer according to claim 1, comprising:
winding the primary coil on the first bobbin;
forming a primary coil unit by performing a first molding process on the first bobbin;
sequentially disposing the 2-2^{nd} coil, the first insulating layer, and the 2-1^{st} coil on the second bobbin;
forming a secondary coil unit by performing a second molding process on the second bobbin; and
assembling the upper core, the primary coil unit, the secondary coil unit, and a lower core.

20. The method of claim 19, wherein the step of forming the secondary coil unit comprises forming the first insulating portion and the second insulating portion in a space of the second bobbin that is not occupied by the secondary coil.
